(19) United States
(12) Patent Application Publication
(10) Pub. No.: US 2016/0363850 A1
(43) Pub. Date: Dec. 15, 2016

(54) OPTICAL PATH CHANGING DEVICE AND PROJECTOR

(71) Applicant: Seiko Epson Corporation, Tokyo (JP)

(72) Inventors: Takahiro Takizawa, Suzaka-shi (JP); Fumihide Sasaki, Azumino-shi (JP)

(21) Appl. No.: 15/174,343

(22) Filed: Jun. 6, 2016

(30) Foreign Application Priority Data
Jun. 11, 2015 (JP) 2015-118091

(51) Int. Cl. G03B 21/20; G02B 7/182

(52) U.S. Cl. CPC G03B 21/2066; G02B 7/182

(57) ABSTRACT

An optical path changing device, that is accommodated in an accommodation section of a projector having a plurality of light sources and that aligns a traveling direction of an incident light beam and emits the light beam, includes: a reflective member that aligns and reflects a light beam incident from each of the plurality of light sources in a predetermined reflection direction; a housing holding the reflective member; and a mounting section (guide rail) which is detachably mounted in the accommodation section.

### BACKGROUND

1. Technical Field

The present invention relates to an optical path changing device and a projector.

2. Related Art

In the related art, there has been known a projector that includes an illuminating device, a light modulating device which modulates a light beam emitted from the illuminating device and which forms an image in response to image information, and a projecting optical device which performs enlarged projection of the image on a projection-target surface such as a screen.

As such a projector, there has been known a projector that includes an illuminating device which combines light beams emitted from a plurality of light sources and emits an illumination light beam (for example, see JP-A-2002-90877).

The illuminating device of the projector disclosed in JP-A-2002-90877 includes two light sources disposed to face each other and an optical path changing member disposed between the two light sources, and two other light sources similarly disposed to face each other and another optical path changing member disposed between the two light sources. Light beams emitted from the respective light sources are reflected from the optical path changing member, collimated, and then, are emitted outside the illuminating device.

Incidentally, since an optical component such as the optical path changing members in the illuminating device disclosed in JP-A-2002-90877 is fixed, as an optical device, in the illuminating device, a problem arises in that it is complicated to perform cleaning of dust attached on the optical component or replacement of the optical component.

### SUMMARY

An advantage of some aspects of the invention is to provide an optical path changing device and a projector in which it is possible to easily perform cleaning of attached dust.

An optical path changing device according to a first aspect of the invention, that is accommodated in an accommodation section of a projector having a plurality of light sources and that aligns a traveling direction of an incident light beam and emits the light beam, includes: a reflective member that aligns and reflects a light beam incident from each of the plurality of light sources in a predetermined reflection direction; a housing holding the reflective member; and a mounting section which is detachably mounted in the accommodation section.

As the light source, a light source device configured to include a solid light source such as a luminous tube, a light emitting diode (LED), or a laser diode (LD), a light source device configured to include a reflector, or a light source device configured to include the solid light source, reflector, and an accommodation body (housing) which accommodates the members, can be used.

In the first aspect, it is possible to configure the optical path changing device that is attachable to and detachable from the accommodation section of the projector and that includes the housing in which the reflective member is provided. In this manner, since the optical path changing device can be removed from the inside of the projector, it is possible to easily perform cleaning of dust attached to the reflective member, compared to a case where the reflective member is directly fixed to the projector.

In the first aspect, it is preferable that, at an end portion of the housing, there is provided a grip section that is gripped when the optical path changing device is attached and detached, and the mounting section is provided on an exterior surface of the housing and is formed in a direction in which the optical path changing device is attached to and detached from the accommodation section.

For example, the grip section is provided on a side opposite to an accommodating direction of the optical path changing device to the accommodation section. In this manner, since an operator can move the optical path changing device by gripping the grip section, it is possible to easily attach and detach the optical path changing device to and from the projector. In addition, when the optical path changing device is accommodated in the accommodation section of the projector, it is possible to easily move the optical path changing device along the mounting section. In this manner, it is possible to easily mount the optical path changing device on the accommodation section of the projector and it is possible to easily remove the optical path changing device.

In the first aspect, it is preferable that the optical path changing device further includes a plurality of the reflective members corresponding to the plurality of light sources; and an optical conversion component that changes optical properties of a light beam reflected from the plurality of reflective members. It is preferable that the housing includes a reflective member holding section that holds the plurality of reflective members, and an optical conversion component holding section that holds the optical conversion component.

As the optical conversion component, in addition to a collimating lens, a rod integrator can be used.

According to the first aspect with this configuration, since it is possible to convert the light beam reflected from the reflective member by the optical conversion component, it is possible to emit a light beam having converted optical properties, from the optical path changing device. In addition, since the optical path changing device can be attached to and detached from the accommodation section of the projector despite the optical conversion component being provided, the housing (optical path changing device) is removed from the projector and it is possible to easily perform cleaning of the dust attached to the reflective member and the optical conversion component.

In the first aspect, it is preferable that the housing is configured to include a first member and a second member which are assembled to each other, and a direction, in which the first member and the second member face each other, is a direction substantially orthogonal to the reflection direction.

According to the first aspect with this configuration, after the optical path changing device is removed from the projector, one of the first member or the second member is removed, and then the optical conversion component and the reflective member are in a state of being exposed to the outside of the housing. In this manner, it is possible to easily perform cleaning of the dust attached to the optical conversion component and the reflective member.

A projector according to a second aspect of the invention includes: an illuminating device that emits a light beam; and an exterior housing having an accommodation section that accommodates the illuminating device inside. The illuminating device includes the optical path changing device described above, and a light source unit having a plurality of light sources that emit a light beam toward the optical path changing device. The light source unit has a regulation section that regulates detachment of the optical path changing device accommodated in the accommodation section.

According to the second aspect, it is possible to achieve the same effects as the optical path changing device. In addition, the regulation section of the light source unit can reduce detachment of the optical path changing device from the projector. In this manner, since the optical path changing device is reliably fixed to the projector, the optical path changing device can reliably reflect the light beam emitted from the light source unit in the predetermined reflection direction.

### BRIEF DESCRIPTION OF THE DRAWINGS

The invention will be described with reference to the accompanying drawings, wherein like numbers reference like elements.

FIG. 1 is a perspective view schematically illustrating a projector according to an embodiment of the invention.

FIG. 2 is a schematic view illustrating an internal configuration of the projector according to the embodiment.

FIG. 3 is a sectional view of a light source device constituting an illuminating device according to the embodiment.

FIG. 4 is a schematic view illustrating a configuration of the illuminating device according to the embodiment.

FIG. 5 is a schematic view illustrating the light source device when viewed in a direction parallel to an emission direction of a light beam emitted from the light source device according to the embodiment.

FIG. 6 is a view illustrating the illuminating device according to the embodiment when viewed from a side in a direction opposite to the emission direction of the light beam.

FIG. 7 is a view illustrating the illuminating device when viewed from the side in a direction opposite to the emission direction of the light beam, in a state in which a first reflective mirror, a second reflective mirror, and a first lens according to the embodiment are removed.

FIG. 8 is a schematic view illustrating the first lens of the illuminating device according to the embodiment.

FIG. 9 is a schematic view illustrating the second lens of the illuminating device according to the embodiment.

FIG. 10 is a perspective view illustrating an optical path changing device according to the embodiment when viewed from a side in a direction opposite to the emission direction of the light beam.

FIG. 11 is a perspective view illustrating a lower surface side of the optical path changing device according to the embodiment when viewed from the side in the emission direction of the light beam.

FIG. 12 is a plan view of an upper surface of the optical path changing device according to the embodiment.

FIG. 13 is a plan view of a lower surface of the optical path changing device according to the embodiment.

FIG. 14 is a front view illustrating the optical path changing device according to the embodiment when viewed from the side in a direction opposite to the emission direction of the light beam.

FIG. 15 is a perspective view illustrating a frame member constituting the housing according to the embodiment when viewed from the side in a direction opposite to the emission direction of the light beam.

FIG. 16 is a perspective view illustrating a frame member according to the embodiment when viewed from the side in the emission direction of the light beam.

FIG. 17 is a perspective view illustrating a second frame member according to the embodiment when viewed from the side in a direction opposite to the emission direction of the light beam.

FIG. 18 is a perspective view illustrating the second frame member when viewed from the side in a direction opposite to the emission direction of the light beam, in a state in which the reflective mirrors, the first lens, and the second lens according to the embodiment are mounted.

FIG. 19 is a partially exploded perspective view illustrating the optical path changing device according to the embodiment when viewed from the side in a direction opposite to the emission direction of the light beam.

FIG. 20 is a plan view illustrating a first lamp unit, a second lamp unit, and the optical path changing device fixed to a base member of the projector according to the embodiment.

FIG. 21 is a right side view illustrating the optical path changing device according to the embodiment.

FIG. 22 is a left side view illustrating the optical path changing device according to the embodiment.

FIG. 23 is a view illustrating a flow path of a cooling gas that cools the optical path changing device according to the embodiment.

### DESCRIPTION OF EXEMPLARY EMBODIMENTS

Hereinafter, an embodiment of the invention will be described on the basis of the drawings.

### Configuration of External Appearance of Projector

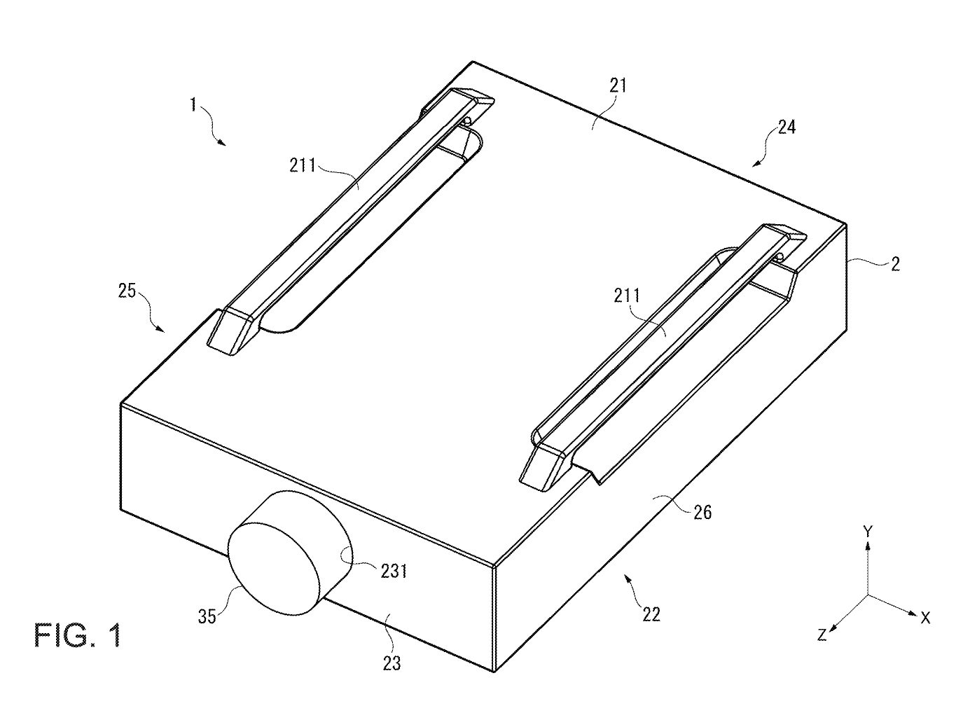

FIG. 1 is a perspective view schematically illustrating a projector 1 according to the present embodiment of the invention.

The projector 1 according to the present embodiment is a projection type display apparatus that modulates a light beam emitted from an illuminating device 31 which will be described below, forms an image in response to image information, and performs enlarged projection of the image on a projection-target surface such as a screen.

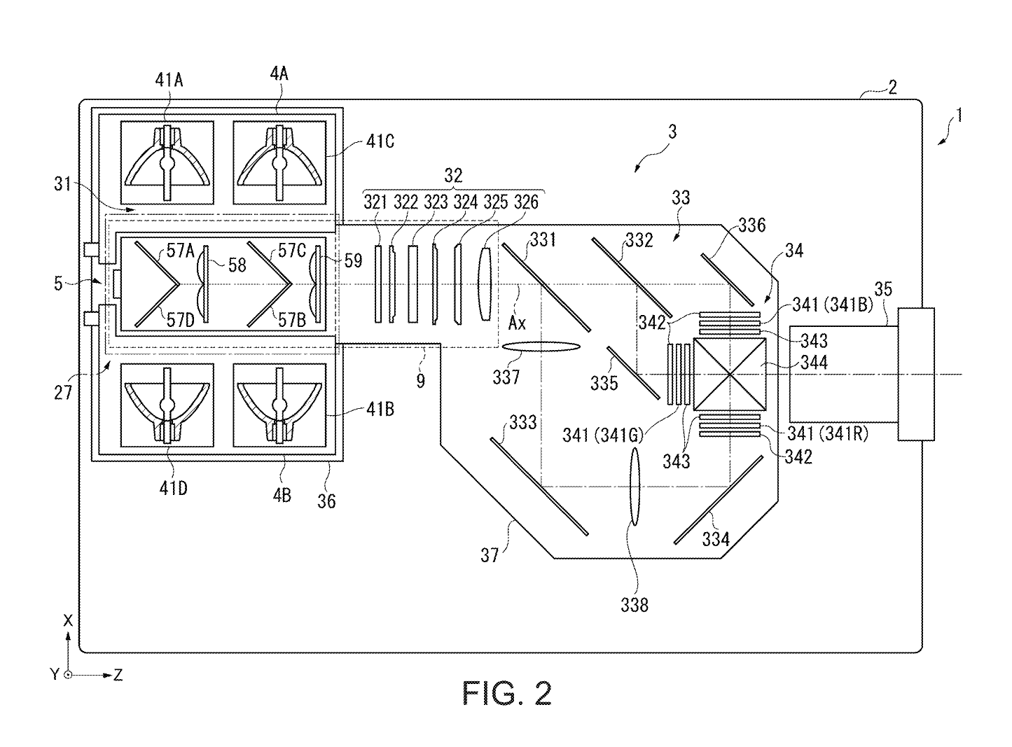

The projector 1 is a multi-lamp type projector including four light source devices 41A to 41D (refer to FIG. 2). Light beams emitted from the four light source devices 41A to 41D are reflected from an optical path changing device 5 to be parallel in the same direction, are emitted from the illuminating device 31, and are incident to a light modulating device through a plurality of optical components, which will be described below in detail.

An exterior housing 2 is formed to have substantially a rectangular parallelepiped shape having a top surface 21, a bottom surface 22, a front surface 23, a rear surface 24, a left side surface 25, and a right side surface 26.

On the top surface 21, a pair of grip sections 211 are provided and used when a user grips the projector 1 or fixes the projector 1 to a tool installed on a ceiling or the like.

On the bottom surface 22, a leg portion (not illustrated) that comes into contact with an installation surface when the projector is mounted on the installation surface such as an installation stage is provided.

An opening 231 is formed in the front surface 23 and a part of projecting optical device 35 constituting an image forming device 3 which will be described below is exposed through the opening.

An opening (not illustrated) is formed in the rear surface 24, is used to accommodate a first lamp unit 4A, a second lamp unit 4B which will be described below (refer to FIG. 2) and the optical path changing device 5 (refer to FIG. 2) in the exterior housing 2 in a replaceable manner, and is covered by a cover member (not illustrated).

Besides, although not illustrated, an introduction port, through which air is introduced from outside to inside of the exterior housing 2, is formed on the right side surface 26, and an exhaust port, through which air is discharged from inside to outside of the exterior housing 2 is formed on the left side surface 25.

### Internal Configuration of Projector

FIG. 2 is a schematic view illustrating an internal configuration of the projector 1.

As illustrated in FIG. 2, the projector 1 includes, in addition to the exterior housing 2, a cooling device 9 that cools the image forming device 3 and components of the projector 1 which are disposed in the exterior housing 2. In addition, an accommodation unit 27 in which the optical path changing device 5 is accommodated is provided in the exterior housing 2, which will be described below in detail. Besides, although not illustrated, the projector 1 includes a control device that controls the projector 1 and a power supply device that supplies power to the electronic components constituting the projector 1.

### Configuration of Image Forming Device

The image forming device 3 forms and projects an image in response to image information input from the control device. The image forming device 3 includes the illuminating device 31, a equalizing device 32, a color separator 33, an electro-optical device 34, a projecting optical device 35, a base member 36, and an optical component housing 37.

Of the above components, the base member 36 connected to the optical component housing 37 has a function of accommodating and fixing the illuminating device 31.

In addition, the optical component housing 37 is a box-shaped housing in which an illumination optical axis Ax is set and the equalizing device 32 and the color separator 33 are disposed at positions on the illumination optical axis Ax in the optical component housing 37. In addition, the illuminating device 31, the electro-optical device 34, and the projecting optical device 35 are positioned outside the optical component housing 37 and disposed according to the illumination optical axis Ax.

The illuminating device 31 emits a collimated light beam to the equalizing device 32. A configuration of the illuminating device 31 will be described below in detail.

The d equalizing device 32 equalizes illuminance in a plane orthogonal to the central axis of luminous flux emitted from the illuminating device 31. The equalizing device 32 includes a cinema filter 321, a first lens array 322, a UV filter 323, a second lens array 324, a polarization converter 325, and a superimposing lens 326.

Of the above components, the polarization converter 325 aligns polarization directions of the incident light beams in one type of direction.

The color separator 33 separates the luminous flux incident from the equalizing device 32 into three color beams of red (R), green (G), and blue (B). The color separator 33 includes dichroic mirrors 331 and 332, reflective mirrors 333 to 336, and relay lenses 337 and 338.

The electro-optical device 34 modulates the respective separated color beams in response to image information and then combines the modulated color beams. The electro-optical device 34 includes a liquid crystal panel 341 (liquid crystal panels for red, green, and blue correspond to 341R, 341G, and 341B, respectively) as a light modulating device provided for each color beam, an incidence-side polarization plate 342, and an emission-side polarization plate 343, and one color synthesis device 344. The color synthesis device 344 can employ a dichroic prism.

The projecting optical device 35 is a projection lens that performs enlarged projection of luminous flux (luminous flux forming an image) synthesized by the color synthesis device 344 on the projection-target surface. As the projecting optical device 35, a lens assembly formed of a plurality of lenses disposed in a lens tube can be employed.

### Configuration of Illuminating Device

As illustrated in FIG. 2, the illuminating device 31 includes a plurality of light source devices fixed to the first lamp unit 4A and the second lamp unit 4B, respectively. The plurality of light source devices correspond to a plurality of light sources (first to fourth light sources) according to the invention and have four light source devices 41 (41A to 41D) in the present embodiment. Besides, the illuminating device 31 includes the optical path changing device 5 that reflects light beams emitted from the light source devices 41A to 41D and aligns and emits the light beams in a predetermined direction. In addition, the first lamp unit 4A includes the light source device 41A and the light source device 41C, and the second lamp unit 4B includes the light source device 41B and the light source device 41D. The first lamp unit 4A and the second lamp unit 4B are disposed on an X direction side and on a side in a direction opposite to the X direction, respectively, with the optical path changing device 5 interposed therebetween. Further, the first lamp unit 4A and the second lamp unit 4B correspond to light source units according to the invention.

### Configuration of Light Source Device

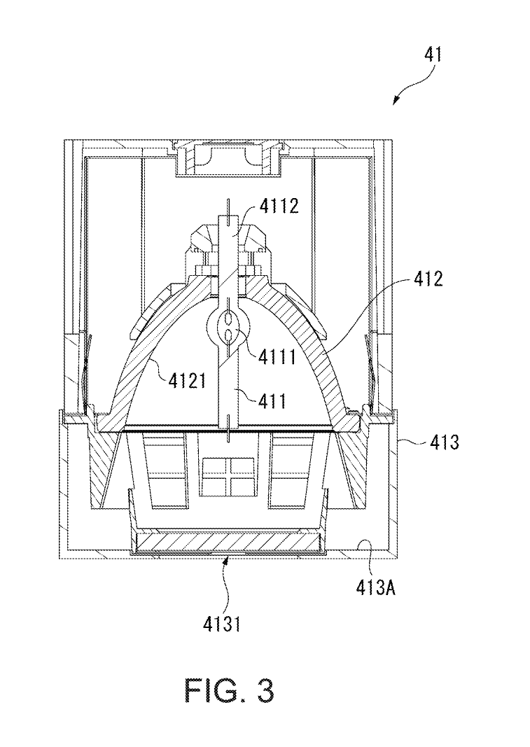

FIG. 3 is a sectional view illustrating a configuration of the light source device 41.

As illustrated in FIG. 2 and FIG. 3, the light source devices 41 include a luminous tube 411, a reflector 412 fixed to a sealing section 4112 positioned on one end side of the luminous tube 411, and an accommodation body 413 that accommodates the above components inside. Of the above components, the reflector 412 aligns and emits light beams emitted from the light emitting portion 4111 of the luminous tube 411 in one direction and is configured as an ellipsoidal reflector of which a reflective surface 4121 is an elliptical surface in the present embodiment.

The accommodation body 413 has a front surface 413A facing a reflective surface 4121 of the reflector 412 and includes an opening 4131 formed to allow a light beam reflected from the reflector 412 and a light beam that is directly incident from the light emitting portion 4111 to pass. The opening 4131 is formed by passing the center of the light emitting portion 4111 and with a virtual line as the center along the central axis of the luminous tube 411.

### Disposition of Light Source Devices

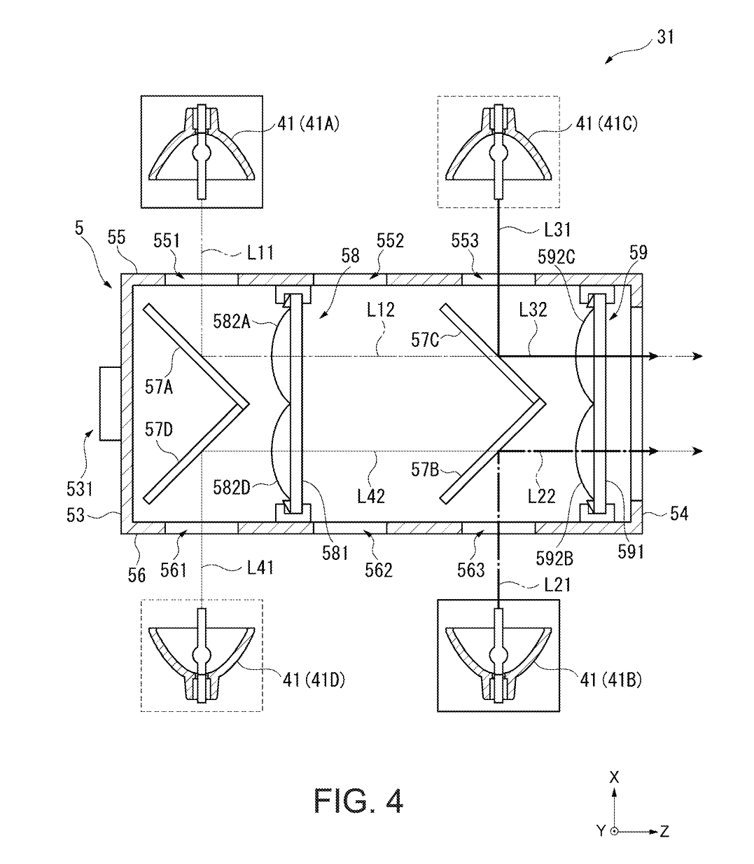

FIG. 4 is a schematic view illustrating a disposition of the light source devices 41A to 41D. Further, in FIG. 4, the first and second lamp units 4A and 4B are omitted. In addition, the optical path changing device 5 is shown in a sectional view such that the internal structure thereof is to be easily understood.

Of the light source devices 41 (41A to 41D) having the configuration described above, as shown in FIG. 4, the light source devices 41A and 41C and the light source devices 41B and 41D are disposed on the sides opposite to each other with the optical path changing device 5 therebetween, and the light source devices 41A to 41D emit light beams toward the optical path changing device 5, respectively.

Further, in the following description, an emission direction of a light beam from the illuminating device 31 is a Z direction, and directions orthogonal to the Z direction and orthogonal to each other are an X direction and a Y direction. In the present embodiment, since the Z direction is a direction from the rear surface 24 toward the front surface 23 in the exterior housing 2, the X direction is a direction from the left side surface 25 toward the right side surface 26 in the exterior housing 2, and the Y direction is a direction from the bottom surface 22 toward the top surface 21 in the exterior housing 2.

The light source devices 41A and 41C are disposed on the X direction side from the optical path changing device 5 and the light source devices 41B and 41D are disposed on the side opposite to the X direction from the optical path changing device 5. Here, the light source device 41A and the light source device 41C are disposed in the order of the light source device 41A and the light source device 41C in the Z direction. Similarly, the light source device 41B and the light source device 41D are disposed in the order of the light source device 41D and the light source device 41B in the Z direction. In this manner, emitted light beams L11 and L31 emitted from the light source device 41A and the light source device 41C are emitted toward the direction opposite to the X direction, and emitted light beams L21 and L41 emitted from the light source device 41B and the light source device 41D are emitted toward the X direction.

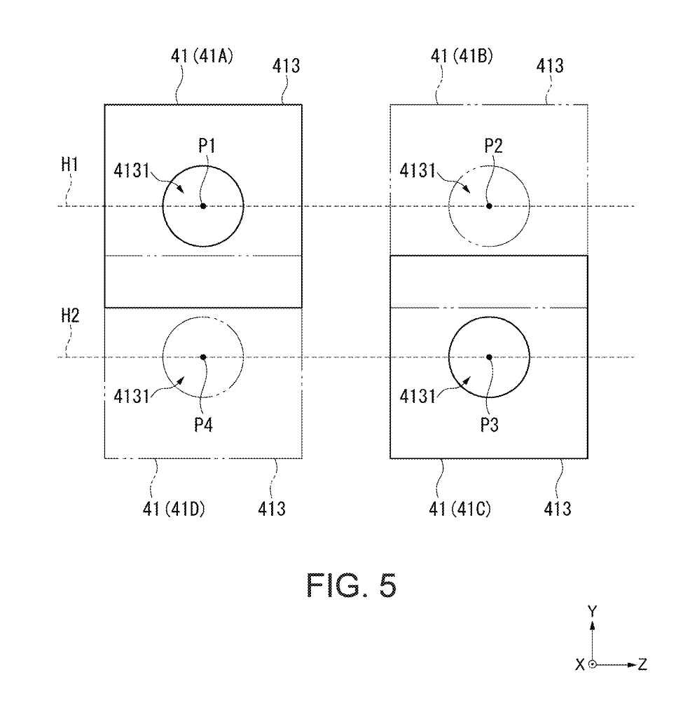

FIG. 5 is a schematic view illustrating the light source devices 41A to 41D when viewed from the X direction side. Further, in FIG. 5, only the accommodation body 413 and the opening 4131 are illustrated in the light source devices 41A to 41D such that it is easy to understand a positional relationship between the light source devices 41A to 41D. In addition, the opening 4131 of the accommodation body 413, in which the light source devices 41A and 41C are accommodated, is depicted in a solid line and the opening 4131 of the accommodation body 413, in which the light source devices 41B and 41D are accommodated, is depicted in a dash line.

As illustrated in FIGS. 4 and 5, a dimension of the accommodation body 413 in the direction parallel to the Y direction is greater than a dimension of the opening 4131 in the same direction. Therefore, in the present embodiment, in a case where the light source device 41D is disposed outside the illumination region of the light source device 41A, there is no need to have different height positions by a dimension of the accommodation body 413 in the direction parallel to the Y direction, but the opening 4131 of the accommodation body 413 in the light source device 41A and the opening 4131 of the accommodation body 413 in the light source device 41D are disposed so as not to be overlapped in a state in which the respective height positions thereof are different in the direction parallel to the Y direction. In other words, a part of the accommodation body 413 of the light source device 41A and a part of the accommodation body 413 of the light source device 41D are overlapped when viewed from a direction parallel to the X direction. Similarly, in a case where the light source device 41C is disposed outside the illumination region of the light source device 41B, the opening 4131 of the accommodation body 413 in the light source device 41B and the opening 4131 of the accommodation body 413 in the light source device 41C are disposed so as not to be overlapped in a state in which the respective height positions thereof are different in the direction parallel to the Y direction. In other words, a part of the accommodation body 413 of the light source device 41B and a part of the accommodation body 413 of the light source device 41C are overlapped when viewed from a direction parallel to the X direction.

In addition, as illustrated in FIG. 5, a first plane H1 including the central axis P1 of the emitted light beam L11 emitted from the light source device 41A and the central axis P2 of the emitted light beam L21 emitted from the light source device 41B is parallel to and is separated from a second plane H2 including the central axis P3 of the emitted light beam L31 emitted from the light source device 41C and the central axis P4 of the emitted light beam L41 emitted from the light source device 41D. In other words, the light source device 41A and the light source device 41B are disposed substantially at the same height position in the direction parallel to the Y direction, and the light source device 41C and the light source device 41D are disposed substantially at the same height position different from the light source devices 41A and 41B.

Of the light source devices 41A to 41D disposed in this manner, the light beam emitted from the light source device 41A is incident to a reflective mirror 57A of the optical path changing device 5, and the light beam emitted from the light source device 41B is incident to a reflective mirror 57B. In addition, the light beam emitted from the light source device 41C is incident to a reflective mirror 57C, and the light beam emitted from the light source device 41D is incident to a reflective mirror 57D.

### Schematic Configuration of Optical Path Changing Device

As described above, the optical path changing device 5 aligns and emits the light beams incident from the light source devices 41 (41A to 41D) in the Z direction and causes the light beams to be incident to the equalizing device 32. The optical path changing device 5 includes a housing 50, the reflective mirrors 57 (57A to 57D) provided corresponding to the light source devices 41 (41A to 41D), a first lens 58, and a second lens 59. Further, the housing 50 that holds the reflective mirrors 57, the first lens 58, and the second lens 59 and a holding structure in the housing 50 will be described below.

The reflective mirror 57A reflects the light beam incident from the light source device 41A in the Z direction. In addition, the reflective mirror 57B reflects the light beam incident from the light source device 41B in the Z direction. Further, the reflective mirror 57C reflects the light beam incident from the light source device 41C in the Z direction. Furthermore, the reflective mirror 57D reflects the light beam incident from the light source device 41D in the Z direction. In other words, the reflective mirrors 57A to 57D have a function of reflecting the incident light beam in the Z direction (direction corresponding to a predetermined reflection direction according to the invention). In addition, the reflected light beams are incident to the equalizing device 32 through the first and second lenses 58 and 59.

As illustrated in FIG. 4, the reflective mirror 57A and the reflective mirror 57D are disposed between the light source device 41A and the light source device 41D, and the reflective mirror 57B and the reflective mirror 57C are disposed between the light source device 41B and the light source device 41C. In addition, the first lens 58 is disposed between the reflective mirrors 57A and 57D and the reflective mirrors 57B and 57C, and the second lens 59 is disposed on the Z direction side from the reflective mirrors 57B and 57C.

Further, the first lens 58 and the second lens 59 correspond to optical conversion components according to the invention.

### Disposition of Reflective Mirrors

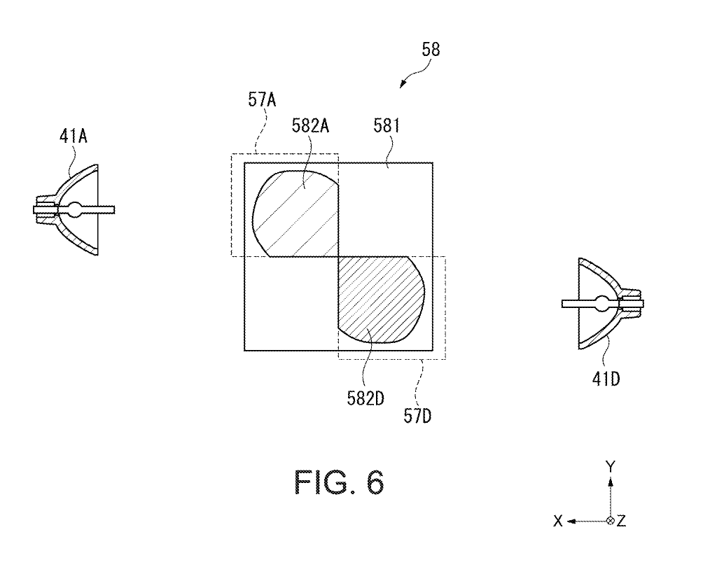

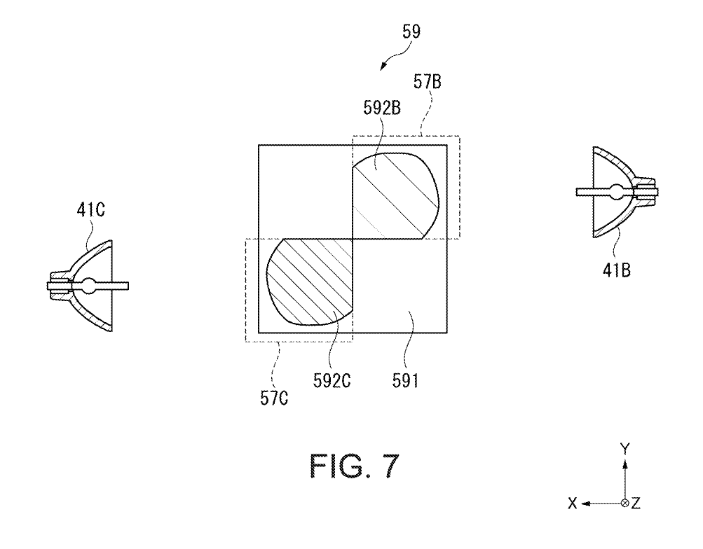

FIG. 6 is a view illustrating the illuminating device 31 when viewed from the side in a direction opposite to the Z direction. FIG. 7 is a view illustrating the illuminating device 31 when viewed from the side in the direction opposite to the Z direction, in a state in which the light source devices 41A and 41D, the reflective mirrors 57A and 57D, and the first lens 58 are removed. Further, in FIGS. 6 and 7, the reflective mirrors 57A to 57D are depicted in a dash line.

As illustrated in FIGS. 4 and 6, the reflective mirror 57A is disposed between the light source device 41A and the light source device 41D, and is disposed at a position facing the light source device 41A. In addition, the reflective mirror 57D is disposed between the light source device 41A and the light source device 41D, and is disposed at a position facing the light source device 41D.

As illustrated in FIGS. 4 and 7, the reflective mirror 57C is disposed between the light source device 41C and the light source device 41B, and is disposed at a position facing the light source device 41C. In addition, the reflective mirror 57B is disposed between the light source device 41C and the light source device 41B, and is disposed at a position facing the light source device 41B.

### Configuration and Disposition of First Lens

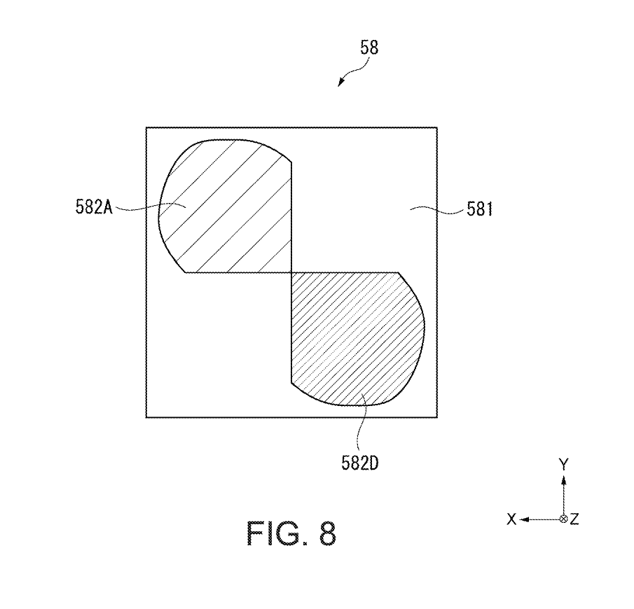

FIG. 8 is a view illustrating the first lens 58 when viewed from the side in the direction opposite to the Z direction.

As illustrated in FIG. 8, the first lens 58 includes a substrate 581 and small lenses 582A and 582D. The small lenses 582A and 582D have a convex shape having a predetermined curvature and have a function of collimating an incident light beam. Further, the curvature of the small lenses 582A and 582D is set to be substantially the same.

In addition, the substrate 581 is formed to have a rectangular plate shape and the small lenses 582A and 582D are formed on a surface of the substrate 581 on the side in the direction opposite to the Z direction.

As illustrated in FIGS. 2 and 4, the first lens 58 is disposed between the reflective mirrors 57A and 57D and the reflective mirrors 57B and 57C in the direction parallel to the Z direction.

### Configuration and Disposition of Second Lens

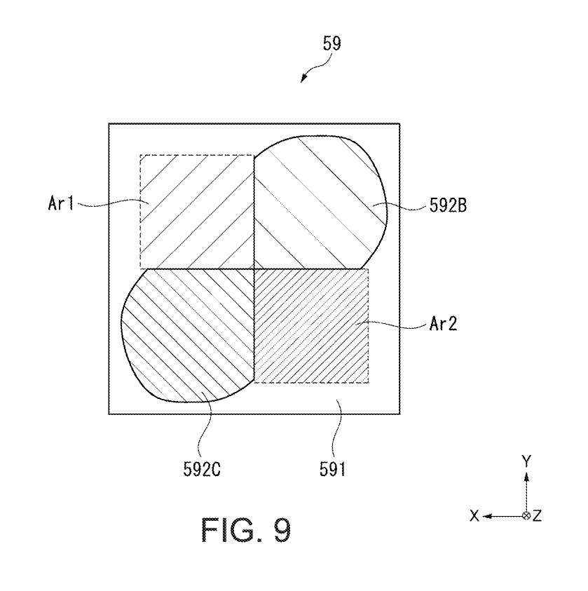

FIG. 9 is a view illustrating the second lens 59 when viewed from the side in the direction opposite to the Z direction.

As illustrated in FIG. 9, the second lens 59 includes a substrate 591 and small lenses 592B and 592C. The small lenses 592B and 592C have a convex shape having a curvature different from the predetermined curvature and have a function of collimating an incident light beam. Further, the curvature of the small lenses 592B and 592C is set to be substantially the same.

The substrate 591 is formed to have a rectangular plate shape and the small lenses 592C and 592B are formed on a surface of the substrate 591 on the side in the direction opposite to the Z direction. In addition, in a region in which the small lenses 592B and 592C of the substrate 591 are not formed, transmission regions Ar1 and Ar2 are formed, and the transmission regions Ar1 and Ar2 have a function of transmitting an incident light beam.

As illustrated in FIGS. 2 and 4, the second lens 59 is disposed on the Z direction side from the reflective mirrors 57B and 57C in the direction parallel to the Z direction.

Here, the reflective mirrors 57A to 57D and the first lens 58 and the second lens 59 disposed in the optical path changing device 5 are fixed in, for example, the housing 50 which will be described below. The optical path changing device 5 will be described below in detail.

### Configuration of Optical Path Changing Device

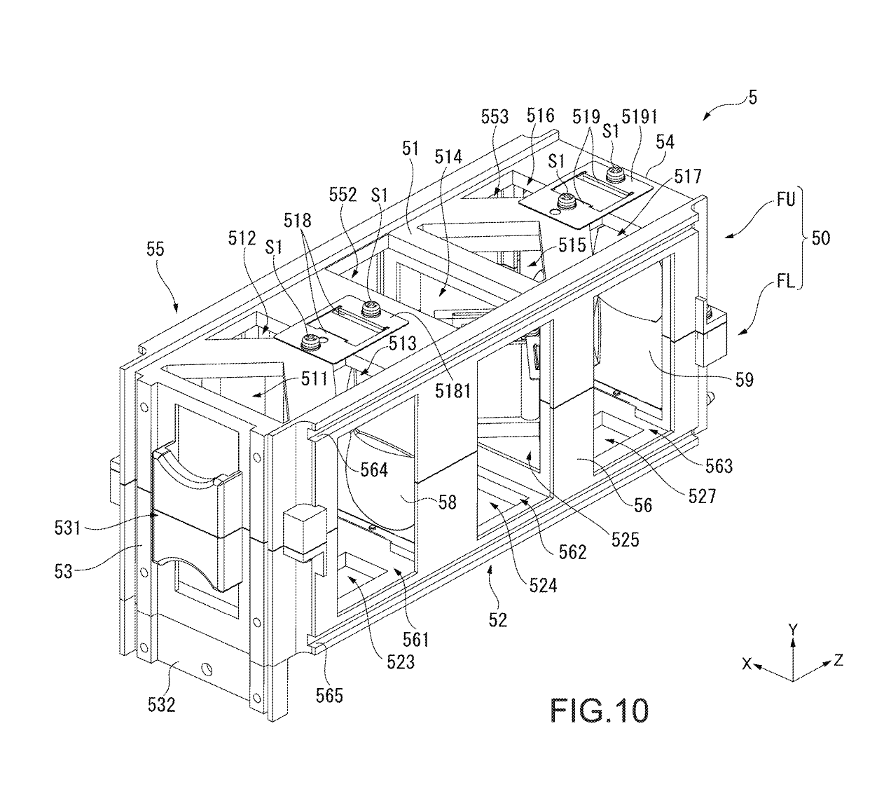

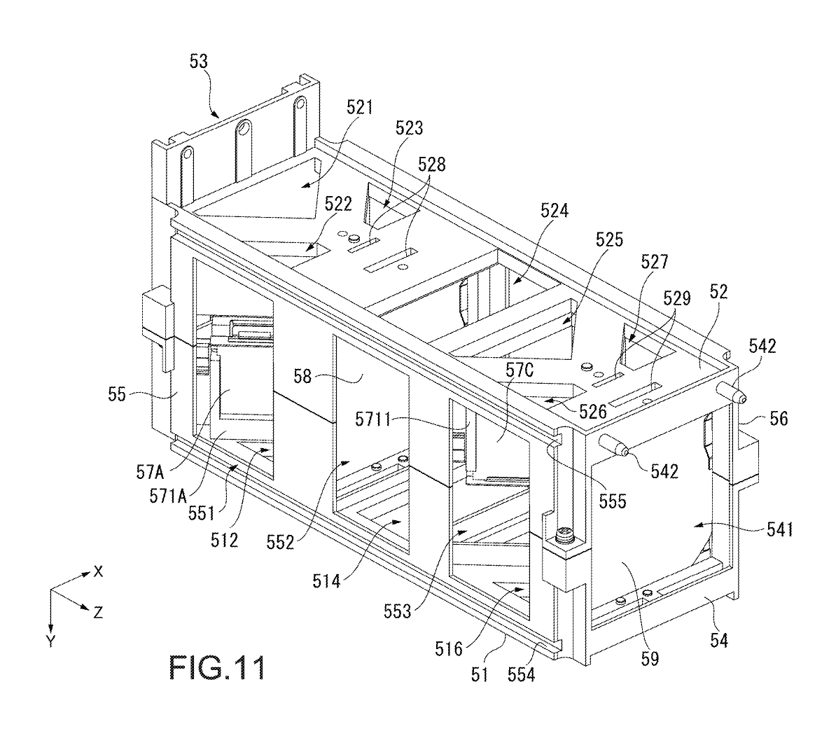

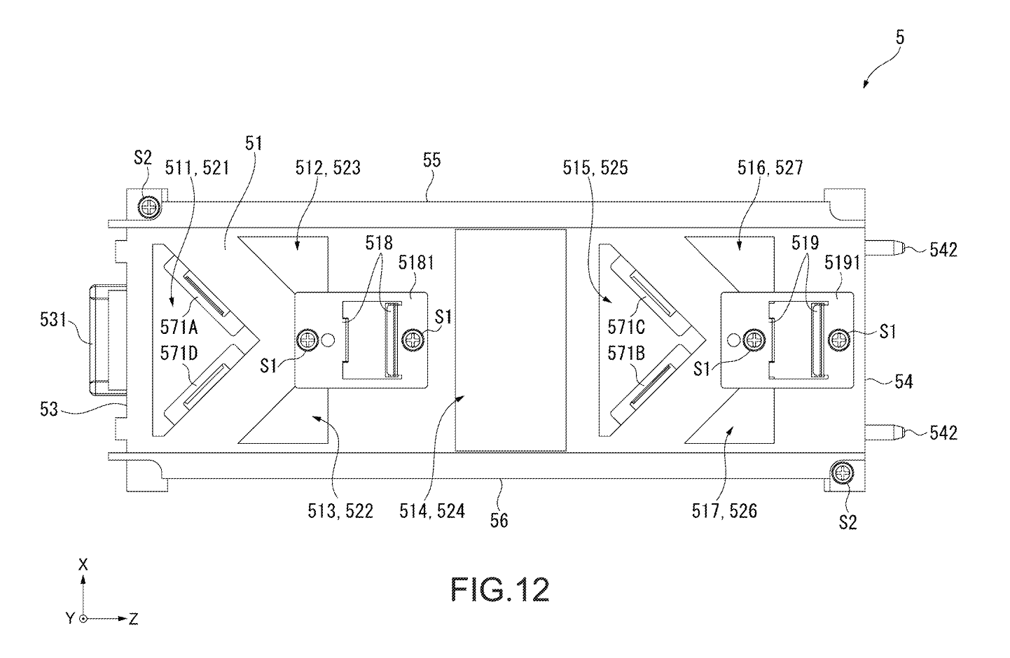

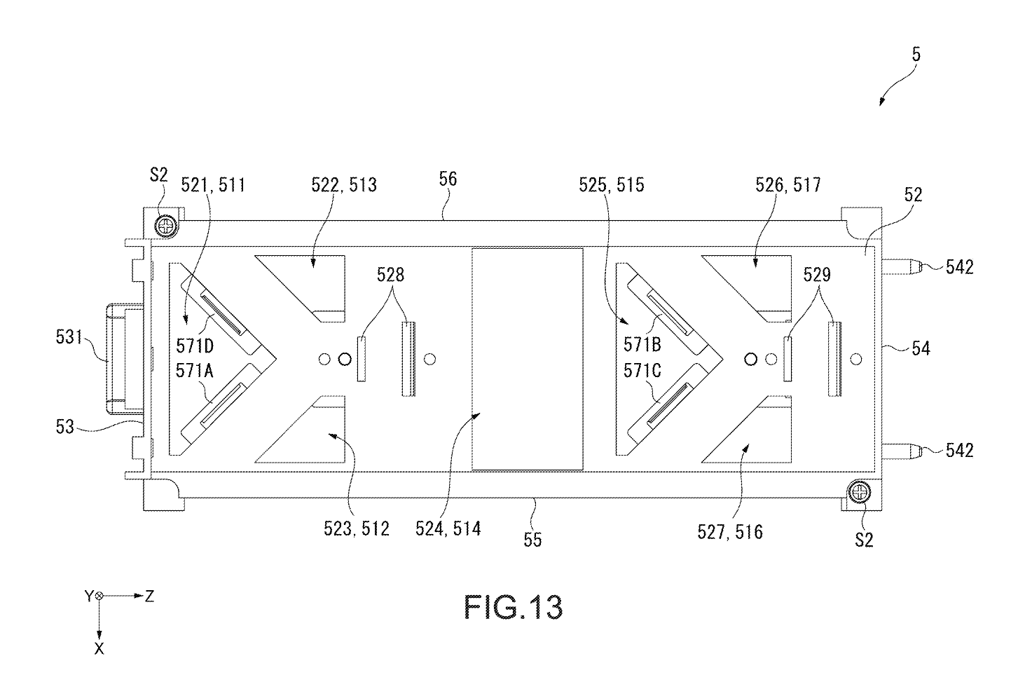

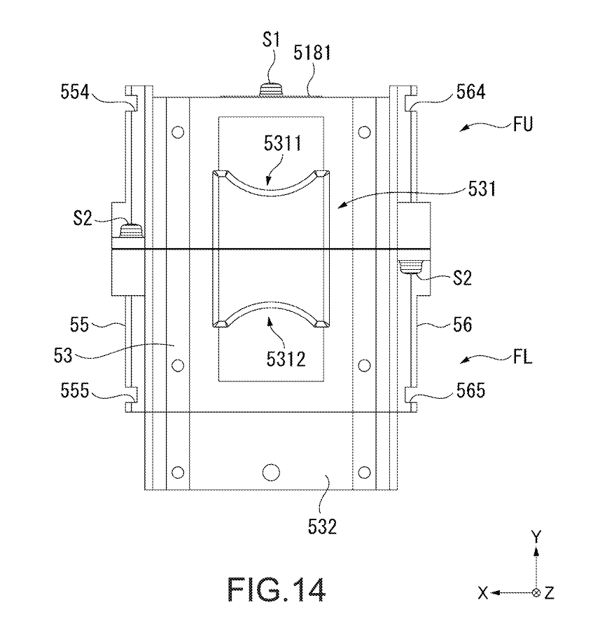

FIG. 10 is a perspective view illustrating an upper surface 51 side, which will be described below, of the optical path changing device 5 when viewed from the side in the direction opposite to the Z direction. FIG. 11 is a perspective view illustrating a lower surface 52 side, which will be described below, of the optical path changing device 5 when viewed from the side in the Z direction. FIG. 12 is a plan view of the optical path changing device 5 when viewed from the side in the Y direction. FIG. 13 is a plan view of the optical path changing device 5 when viewed from the side in the direction opposite to the Y direction. FIG. 14 is a front view illustrating the optical path changing device 5 when viewed from the side in the direction opposite to the Z direction.

As illustrated in FIGS. 10 to 14, the optical path changing device 5 includes the housing 50. The housing 50 is configured to include a first frame member FU and a second frame member FL which are molded by aluminum die casting, which will be described below in detail. The housing 50 is formed to have substantially a rectangular parallelepiped shape having the upper surface 51, the lower surface 52, a light shielding surface 53, an emitting surface 54, a first side surface 55, and a second side surface 56.

Further, the first frame member FU corresponds to a first member according to the invention and the second frame member FL corresponds to a second member according to the invention.

### Configuration of Upper Surface and Lower Surface

As illustrated in FIGS. 10 to 14, on the upper surface 51, a plurality of openings 511 to 517 and grooves 518 and 519 are formed. In addition, on the lower surface 52, a plurality of openings 521 to 527 and grooves 528 and 529 are formed. Of the plurality of openings 511 to 517 and 521 to 527, the openings 511 and 521 are formed to have substantially a triangular shape on the outermost side in the direction opposite to the Z direction on the upper surface 51 and the lower surface 52, respectively. In addition, the openings 512 and 513 and the openings 522 and 523 face each other in the direction parallel to the X direction and are formed to have substantially a trapezoidal shape between the openings 511 and 521 and the grooves 518 and 528. Further, the rectangular openings 514 and 524 are formed on the Z direction side from the grooves 518 and 528, and the openings 515 and 525 having the same shape as the openings 511 and 521 are formed on the Z direction side from the openings 514 and 524. Furthermore, the openings 516 and 526 and the openings 517 and 527 having the same shape as the openings 512 and 522 and the openings 513 and 523 are formed on the Z direction side from the openings 515 and 525. Also, the grooves 519 and 529 having the same shape as the grooves 518 and 528 are formed at outermost positions on the Z direction side on the upper surface 51 and the lower surface 52.

As illustrated in FIGS. 12 and 13, the openings 511 and 521 are formed at positions at which cooling can be performed on a surface of holding sections 571A and 571D on the side in the direction opposite to the Z direction, which holds the reflective mirrors 57A and 57D. Similarly, the openings 515 and 525 are formed at positions at which cooling can be performed on a surface of holding sections 571B and 571C on the side in the direction opposite to the Z direction, which holds the reflective mirrors 57B and 57C. A cooling gas supplied from the cooling device 9 is circulated from the openings 521 and 525 toward the openings 511 and 515, which will be described below in detail. In this manner, the holding sections 571A to 571D are cooled with the cooling gas.

Further, the holding sections 571A to 571D correspond to reflective member holding sections according to the invention.

In addition, as illustrated in FIGS. 10 and 12, leaf spring members 5181 and 5191 are fixed to the grooves 518 and 519 on the upper surface 51, respectively, by screws S1. The leaf spring members 5181 and 5191 have projecting portions (not illustrated) which are inserted into the grooves 518 and 519, and are fixed to the upper surface 51 by the screws S1 in a state in which the projecting portions are inserted into the grooves 518 and 519. The projecting portions inserted into the grooves 518 and 519 have a function of pinching the first lens 58 and the second lens 59. In other words, the leaf spring members 5181 and 5191 have a function of holding the first and second lenses 58 and 59 on the upper surface 51 side, that is, on the Y direction side.

### Configuration of Light Shielding Surface

The light shielding surface 53 has a function of reducing leakage of the emitted light beam emitted from the light source devices 41A to 41D toward the first and second side surfaces 55 and 56 of the optical path changing device 5, in the direction opposite to the Z direction. Therefore, as illustrated in FIG. 14, no opening is formed in the light shielding surface 53, unlike the upper surface 51, the lower surface 52, the emitting surface 54, the first and second side surfaces 55 and 56. In addition, the light shielding surface 53 includes a grip section 531 and an extending section 532. As illustrated in FIGS. 10 and 14, the grip section 531 is formed substantially at the central portion of the light shielding surface 53. The grip section 531 has recessed portions 5311 and 5312 that are recessed to the side in the direction opposite to the Y direction and to the side in the Y direction at an end portion of the grip section on the side in the Y direction and at the other end portion thereof on the side in the direction opposite to the Y direction, respectively.

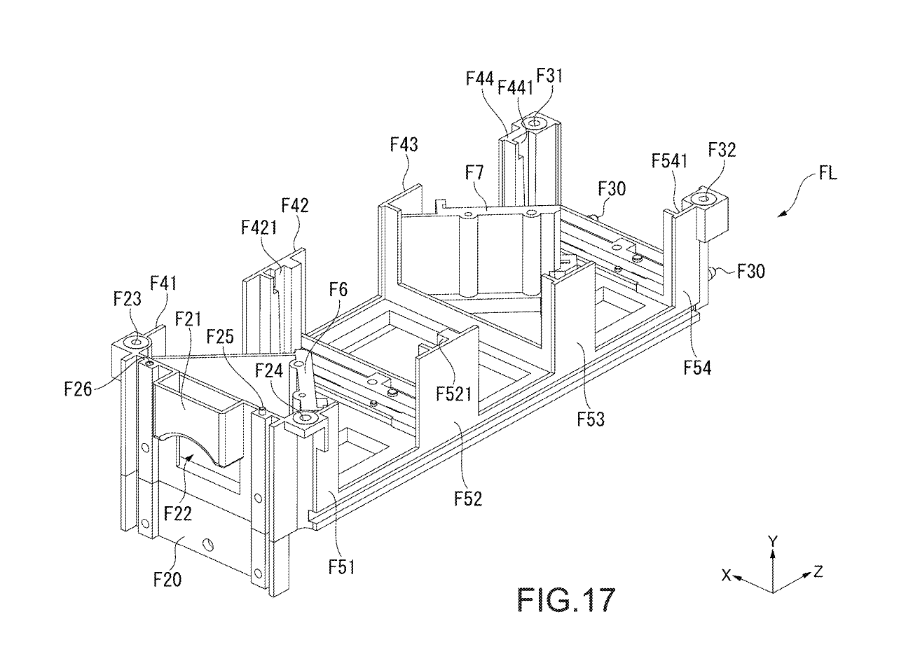

In addition, the extending section 532 is configured of a rectangular extending member F20 connected to an end portion of the second frame member FL on the side in the direction opposite to the Y direction, of the first frame member FU and the second frame member FL constituting the light shielding surface 53 (refer to FIG. 17).

### Configuration of Emitting Surface

The emitting surface 54 has a function of emitting a light beam of which a direction is aligned by the optical path changing device 5, toward the equalizing device 32 positioned in the Z direction. Therefore, as illustrated in FIG. 11, a rectangular opening 541 is formed substantially at the central portion of the emitting surface 54. The opening 541 is formed to have substantially the same size as a region including the small lenses 592B and 592C and the transmission regions Ar1 and Ar2 in the substrate 591 of the second lens 59. In addition, two protrusions 542 that protrude in the Z direction are formed at an end portion of the emitting surface 54 on the Y direction side. The protrusions 542 are connected to the base member 36 when the optical path changing device 5 is mounted in the projector 1.

### Configuration of Side Surface

As illustrated in FIG. 11, three openings 551, 552, and 553 and guide rails 554 and 555 are formed on the first side surface 55. The three openings 551 to 553 are formed to have rectangular shapes, respectively, and, as illustrated in FIG. 4, the opening 551 is formed at a position facing the light source device 41A. In this manner, the emitted light beam. L11 emitted from the light source device 41A is incident to the optical path changing device 5 through the opening 551. In addition, the opening 553 is formed at a position facing the light source device 41C, and the emitted light beam L31 emitted from the light source device 41C is incident to the optical path changing device 5 through the opening 551. Further, the opening 552 is formed between the opening 551 and the opening 553.

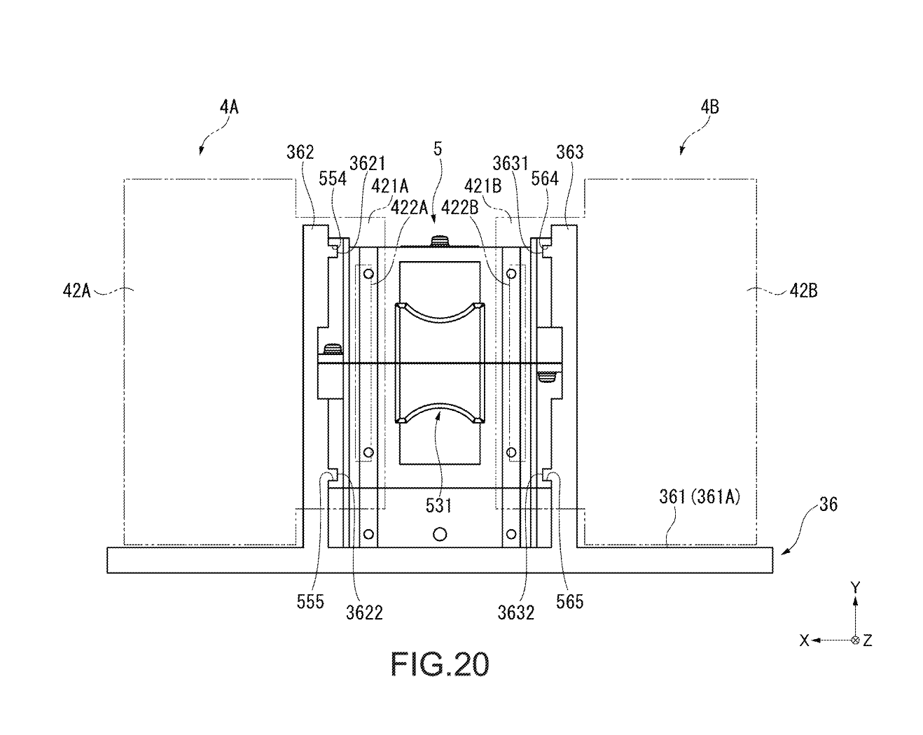

As illustrated in FIGS. 11 and 14, the guide rails 554 and 555 are formed on the Y direction side and on the side in the direction opposite to the Y direction with the openings 551 to 553 interposed therebetween. Specifically, the guide rail 554 is formed along an edge portion of the first side surface 55 on the Y direction side and the guide rail 555 is formed along an edge portion of the first side surface 55 on the side in the direction opposite to the Y direction. The guide rails 554 and 555 are engaged with engagement portions 3621 and 3622 of the base member 36 (refer to FIG. 20).

As illustrated in FIG. 10, three openings 561, 562, and 563 and guide rails 564 and 565 are formed on the second side surface 56. The three openings 561 to 563 are formed to have rectangular shapes, respectively, and, as illustrated in FIG. 4, the opening 561 is formed at a position facing the light source device 41D. In this manner, the emitted light beam L41 emitted from the light source device 41D is incident to the optical path changing device 5 through the opening 561. In addition, the opening 563 is formed at a position facing the light source device 41B, and the emitted light beam L21 emitted from the light source device 41B is incident to the optical path changing device 5 through the opening 561. Further, the opening 562 is formed between the opening 561 and the opening 563. The openings 551 to 553 and the openings 561 to 563 are formed to have substantially the same shapes, respectively.

As illustrated in FIGS. 10 and 14, the guide rails 564 and 565 are formed on the Y direction side and on the side in the direction opposite to the Y direction with the openings 561 to 563 interposed therebetween. Specifically, the guide rail 564 is formed along an edge portion of the second side surface 56 on the Y direction side and the guide rail 565 is formed along an edge portion of the second side surface 56 on the side in the direction opposite to the Y direction. The guide rails 564 and 565 are engaged with engagement portions 3631 and 3632 of the base member 36 (refer to FIG. 20).

Further, the guide rails 554, 555, 564, and 565 correspond to mounting sections according to the invention.

### Configuration of Frame Member

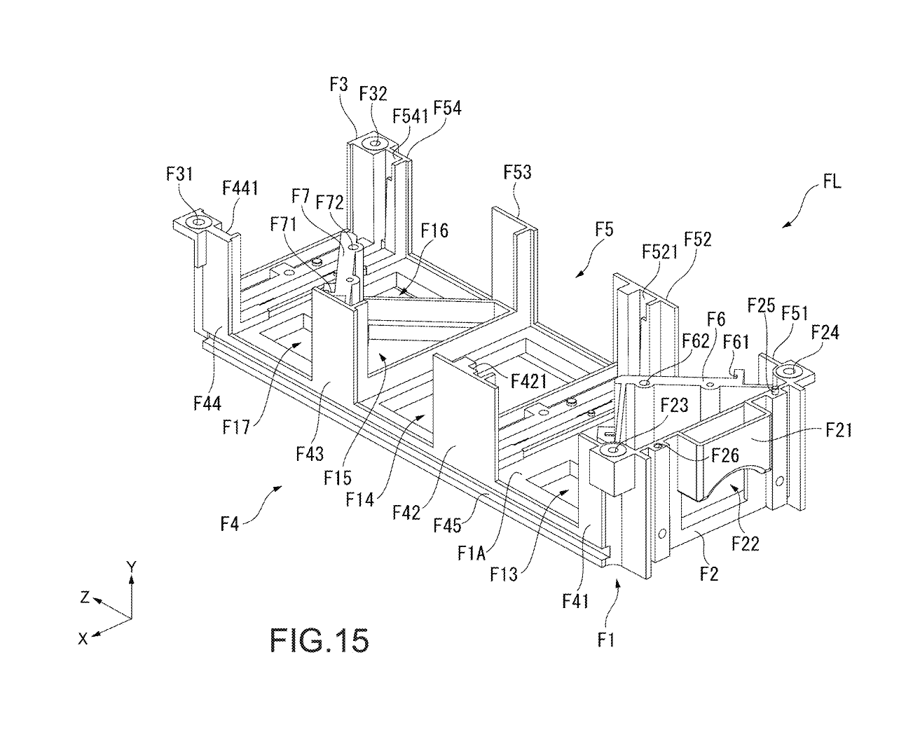

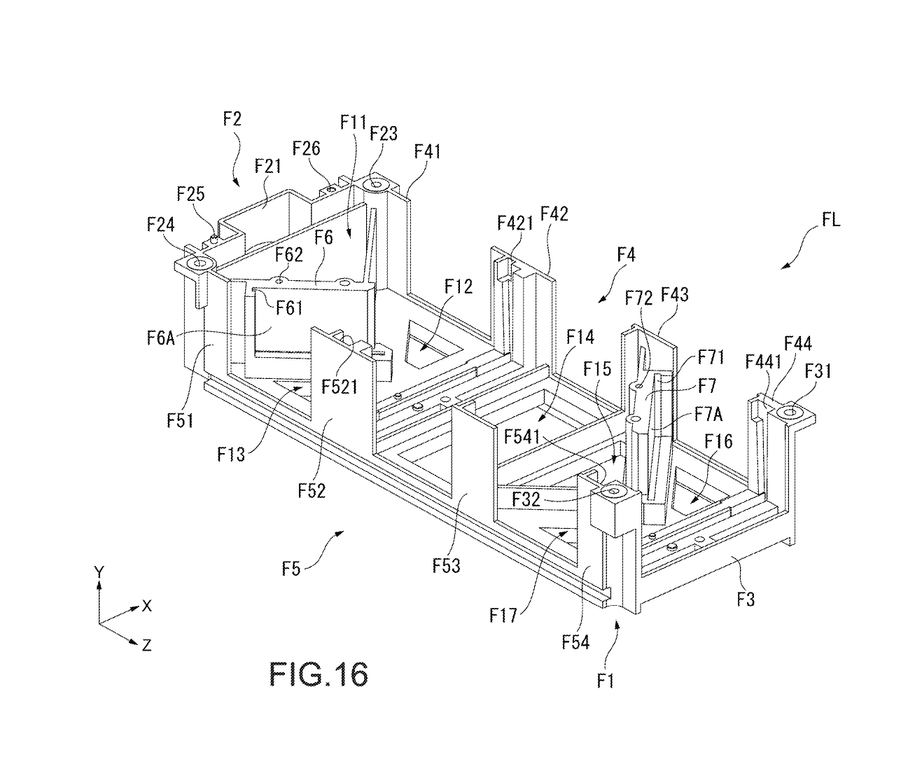

FIG. 15 is a perspective view illustrating a frame member F constituting the housing 50 when viewed from the side in the direction opposite to the Z direction. FIG. 16 is a perspective view illustrating the frame member F when viewed from the Z direction side.

As illustrated in FIG. 10, the housing 50 of the optical path changing device 5 is configured to include the two frame members FU and FL. Of the two frame members FU and FL, a frame member that is disposed on the Y direction side and configures the upper surface 51 of the housing 50 is the first frame member FU and a frame member that configures the lower surface 52 is the second frame member FL. The first frame member FU and the second frame member FL are aluminum die casting products having substantially the same shape, by injection molding using the same die. In other words, the dimension of the first frame member FU and the second frame member FL in the Y direction is substantially the same. Therefore, in the following description, only the second frame member FL will be described and the description of the first frame member FU will be omitted.

As illustrated in FIGS. 15 and 16, the second frame member FL includes a lower surface constituting section F1, a light shielding surface constituting section F2, an emitting surface constituting section F3, a first side surface constituting section F4, and a second side surface constituting section F5. Of the sections, one of the upper surface 51 and the lower surface 52 of the housing 50 is constituted with the lower surface constituting section F1. The lower surface constituting section F1 has openings F11 to F17 corresponding to the plurality of openings 511 to 517 and 521 to 527 of the housing 50, respectively, and mirror fixing sections F6 and F7 that extend in the Y direction from an inner surface F1A are formed on the inner surface F1A on the side in the direction opposite to the Y direction. The mirror fixing sections F6 and F7 have a function of fixing the reflective mirrors 57A to 57D. The mirror fixing section F6 is formed between the opening F11 and the opening F13 of the inner surface F1A and the mirror fixing section F7 is formed between the opening F15 and the opening F16 of the inner surface F1A.

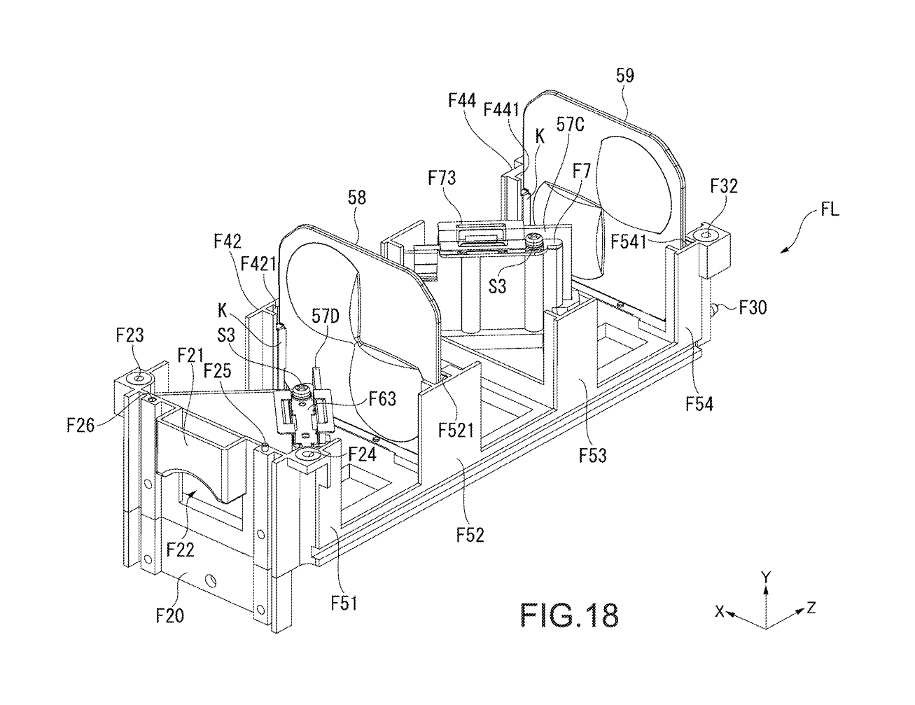

The mirror fixing sections F6 and F7 include mirror fixing reference surfaces F6A and F7A set at an angle at which the emitted light beams emitted from the light source devices 41A to 41D, respectively, are reflected toward the Z direction. Specifically, the mirror fixing reference surface F6A of the mirror fixing section F6 is formed on the opening F13 side. Similarly, the mirror fixing reference surface F7A of the mirror fixing section F7 is formed on the opening F16 side. In addition, the mirror fixing sections F6 and F7 include substantially L-shaped grooves F61 and F71 formed along the mirror fixing reference surfaces F6A and F7A. Further, two holes F62 and F72 are formed at end portions of the mirror fixing sections F6 and F7 on the Y direction side. In this manner, the reflective mirrors 57A to 57D are fitted to the grooves F61 and F71 of the mirror fixing sections F6 and F7, respectively, and are screwed and fixed through the holes F62 and F72 (refer to FIG. 18).

Further, the mirror fixing sections F6 and F7 constitute a part of the holding sections 571A to 571D of the housing 50. In addition, the mirror fixing sections F6 and F7 are molded by the aluminum die casting. Therefore, when the temperatures of the reflective mirrors 57A to 57D are increased by the emitted light beams L11 to L41, the heat of the reflective mirrors 57A to 57D is transmitted to the mirror fixing sections F6 and F7.

The light shielding surface constituting section F2 constitutes a part of the light shielding surface 53 of the housing 50. The light shielding surface constituting section F2 includes a grip member F21, a recessed portion F22, holes F23 and F24, a protrusion F25 and a recessed portion F26. The grip member F21 corresponds to a part of the grip section 531. The grip member F21 is provided substantially at the central portion of the light shielding surface constituting section F2 and has a shape of extending to the end portion on the Y direction side. In addition, the recessed portion F22 is formed at an end portion of the grip member F21 on the side in the direction opposite to the Y direction. The recessed portion F22 corresponds to the recessed portions 5311 and 5312 of the housing 50. Further, the holes F23 and F24 are formed on both sides of the light shielding surface constituting section F2. Furthermore, the protrusion F25 and the recessed portion F26 are disposed at the end portions of the light shielding surface constituting section F2 on the Y direction side, at positions facing each other with the grip member F21 interposed therebetween. The protrusion F25 is formed to have a shape so as to be fitted into the recessed portion F26. Therefore, when the first frame member FU is disposed to be stacked on the second frame member FL, the protrusion F25 of the first frame member FU is fitted into the recessed portion F26 of the second frame member FL and the protrusion F25 of the second frame member FL is fitted into the recessed portion F26 of the first frame member FU. In other words, the protrusion F25 and the recessed portion F26 have a function of a positioning member.

The emitting surface constituting section F3 constitutes a part of the emitting surface 54 of the housing 50. The emitting surface constituting section F3 is formed to have a substantial U shape and holes F31 and F32 are formed on both side portions of the emitting surface constituting section F3. Specifically, when the first frame member FU is disposed to be stacked on the second frame member FL, the holes F31 and F32 of the first frame member FU are overlapped with the holes F31 and F32 of the second frame member FL and screws S2 are screwed in the holes F31 and F32, thereby firmly fixing the first frame member FU and the second frame member FL (refer to FIGS. 12 and 13).

The first side surface constituting section F4 includes a plurality of upright portions F41, F42, F43, F44, and a guide rail F45. The upright portions F41 to F44 are formed to have rectangular shapes extending toward the Y direction from the end portion of the lower surface constituting section F1 on the X direction side. Of the upright portions, the upright portion F41 is positioned on the outermost side in the direction opposite to the Z direction and is connected to the light shielding surface constituting section F2. In addition, the upright portion F42 is positioned on the Z direction side from the upright portion F41 and the upright portion F43 is positioned on the Z direction side from the upright portion F42. Further, the upright portion F44 is positioned on the outermost side in the Z direction and is connected to the emitting surface constituting section F3. The guide rail F45 is formed on the side in the direction opposite to the Y direction from the upright portions F41 to F44 on the side of the first side surface constituting section F4 in the direction opposite to the Y direction and is configured of a groove extending in the direction parallel to the Z direction. Grooves F421 and F441 extending in the Y direction are formed on the inner side surface of the upright portions F42 and F44. The first lens 58 and the second lens 59 are fitted in the grooves F421 and F441, respectively.

Further, the guide rail F45 corresponds to guide rails 554 and 565 of the housing 50.

The second side surface constituting section F5 includes a plurality of upright portions F51, F52, F53, F54, and a guide rail F55. The upright portions F51 to F54 are formed to have rectangular shapes extending toward the Y direction from the end portion of the lower surface constituting section F1 on the side in the direction opposite to the X direction. Of the upright portions, the upright portion F51 is positioned on the outermost side in the direction opposite to the Z direction and is connected to the light shielding surface constituting section F2. In addition, the upright portion F52 is positioned on the Z direction side from the upright portion F51 and the upright portion F53 is positioned on the Z direction side from the upright portion F52. Further, the upright portion F54 is positioned on the outermost side in the Z direction and is connected to the emitting surface constituting section F3. The guide rail F55 is formed on the side in the direction opposite to the Y direction from the upright portions F51 to F54 on the side of the second side surface constituting section F5 in the direction opposite to the Y direction and is configured of a groove extending in the direction parallel to the Z direction. Grooves F521 and F541 extending in the Y direction are formed on the inner side surface of the upright portions F52 and F54. The first lens 58 and the second lens 59 are fitted in the grooves F521 and F541, respectively. Further, the guide rail F55 corresponds to guide rails 555 and 564 of the housing 50.

### Assembling Method of Optical Path Changing Device

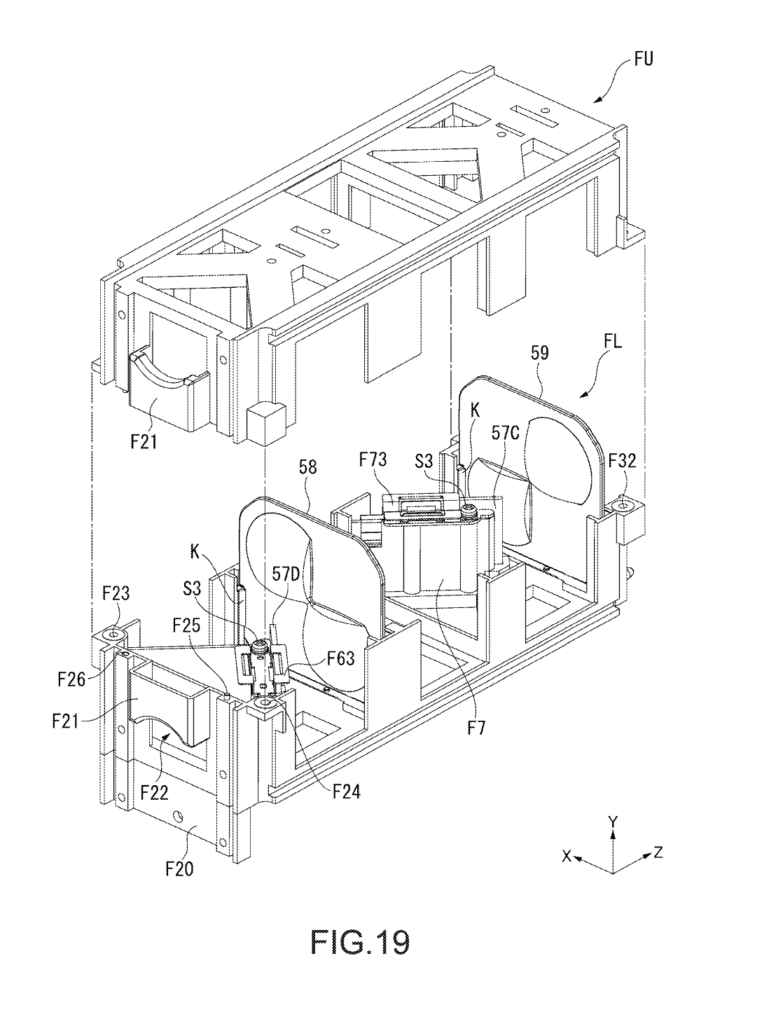

FIG. 17 is a perspective view illustrating the second frame member FL when viewed from the side in the direction opposite to the Z direction. FIG. 18 is a perspective view illustrating the second frame member FL when viewed from the side in the direction opposite to the Z direction, in a state in which the reflective mirrors 57C and 57D, the first lens 58, and the second lens 59 are mounted. FIG. 19 is a partially exploded perspective view illustrating the optical path changing device 5 when viewed from the side in the direction opposite to the Z direction. Further, in FIG. 19, the mirror fixing portions F6 and F7 are omitted in the first frame member FU.

First, as illustrated in FIG. 17, an operator mounts an extending member F20 in the light shielding surface constituting section F2 of the second frame member FL which is in the state illustrated in FIGS. 15 and 16. In addition, the operator mounts a protrusion F30 to the emitting surface constituting section F3. Further, the extending member F20 constitutes a part of the light shielding surface 53 of the housing 50 and the protrusion F30 constitutes the protrusion 542 of the housing 50.

Then, as illustrated in FIG. 18, the operator fits the reflective mirrors 57C and 57D in the grooves F61 and F71 along the mirror fixing reference surfaces F6A and F7A of the mirror fixing sections F6 and F7. Then, the reflective mirrors 57C and 57D are covered by the fixing members F63 and F73 and the screws S3 are screwed in the holes F62 and F72. In this manner, the reflective mirrors 57C and 57D are screwed and fixed to the mirror fixing sections F6 and F7 through the holes F62 and F72.

Further, the operator performs the same operations also on the first frame member FU, which is not illustrated. Specifically, the operator fits the reflective mirrors 57A and 57B in the grooves F61 and F71 along the mirror fixing reference surfaces F6A and F7A of the mirror fixing sections F6 and F7 of the first frame member FU. Then, the reflective mirrors 57A and 57B are covered by the fixing members F63 and F73 and the screws S3 are screwed in the holes F62 and F72. In this manner, the reflective mirrors 57A and 57B are screwed and fixed to the mirror fixing sections F6 and F7 through the holes F62 and F72.

Back to FIG. 18, the operator fits the first lens 58 in the grooves F421 and F521 formed in the upright portions F42 and F52 of the second frame member FL to which the reflective mirrors 57C and 57D are fixed. Then, the operator fits the leaf spring member K between the grooves F421 and F521 and the first lens 58. Similarly, the operator fits the second lens 59 in the grooves F441 and F541 formed in the upright portions F44 and F54. Then, the operator fits the leaf spring member K between the grooves F441 and F541 and the second lens 59. In this manner, the first lens 58 and the second lens 59 are fixed to the second frame member FL.

Further, the grooves F421, F441, F521, and F541 correspond to optical conversion component holding sections according to the invention.

Then, as illustrated in FIG. 19, the operator stacks the first frame member FU on the second frame member FL. At this time, the protrusion F25 formed in the light shielding surface constituting section F2 of the first frame member FU and the second frame member FL is positioned to be fit in the recessed portion F26, and the first frame member FU is stacked on the second frame member FL. Then, the operator screws the screws S2 into the holes F23, F24, F31, and F32. In this manner, the first frame member FU and the second frame member FL are fixed and constitute the housing 50. In this manner, the optical path changing device 5 is configured.

### Attachment Structure of Optical Path Changing Device

FIG. 20 is a plan view illustrating the first lamp unit 4A, the second lamp unit 4B, and the optical path changing device 5 fixed to the base member 36 of the projector 1.

As illustrated in FIG. 20, the optical path changing device 5 is mounted on the base member 36 of the projector 1. The base member 36 includes a bottom surface 361 and extending sections 362 and 363. The bottom surface 361 is fixed to the bottom surface 22 of the projector 1. The plate-shaped extending sections 362 and 363 extending to the Y direction side are fixed to the bottom surface 361. The extending section 362 has two engagement portions 3621 and 3622 protruding from a surface 362A of the extending section 362 on the side in the direction opposite to the X direction toward the side in the direction opposite to the X direction. The engagement portion 3621 is engaged with the guide rail 554 of the optical path changing device 5 and the engagement portion 3622 is engaged with the guide rail 555 of the optical path changing device 5. In comparison, the extending section 363 has two engagement portions 3631 and 3632 protruding from a surface 363A of the extending section 363 on the X direction side toward the X direction side. The engagement portion 3631 is engaged with the guide rail 564 of the optical path changing device 5 and the engagement portion 3632 is engaged with the guide rail 565 of the optical path changing device 5.

As illustrated in FIG. 20, the first lamp unit 4A includes an extending section 421A extending from a rectangular surface 42A on the side in the direction opposite to the Z direction toward the side opposite to the X direction. The extending section 421A is fixed to be stacked on a part of the optical path changing device 5 when the first lamp unit 4A is fixed to the base member 36. In addition, the second lamp unit 4B includes an extending section 421B extending from a rectangular surface 42B on the side in the direction opposite to the Z direction toward the X direction side. The extending section 421B is fixed to be stacked on a part of the optical path changing device 5 when the second lamp unit 4B is fixed to the base member 36. In other words, the first lamp unit 4A and the second lamp unit 4B are fixed by the extending sections such that the extending sections 421A and 421B cover the end portion of the optical path changing device 5 on the X direction side and the end portion thereof on the side in the direction opposite to the X direction.

In addition, the first lamp unit 4A includes a grip section 422A protruding from the extending section 421A to the side in the direction opposite to the Z direction. Further, the second lamp unit 4B includes a grip section 422B protruding from the extending section 421B to the side in the direction opposite to the Z direction. The grip sections 422A and 422B are formed to have a substantial U shape.

According to such a configuration, the operator grips the grip section 531 of the optical path changing device 5, engages the guide rails 554, 555, 564, and 565 with the engagement portions 3621, 3622, 3631, and 3632, and pushes the device in the Z direction, thereby, fixing the optical path changing device 5 to the base member 36. Then, the operator grips the grip sections 422A and 422B of the first lamp unit 4A and the second lamp unit 4B, and pushes the optical path changing device 5 in the Z direction so as to be interposed therebetween, thereby fixing the first lamp unit 4A and the second lamp unit 4B to the base member 36. In other words, the illuminating device 31 is fixed in the projector 1.

In a case where the first lamp unit 4A, the second lamp unit 4B, and the optical path changing device 5 are removed from the projector 1 for maintenance or the like, the grip sections 422A and 422B of the first lamp unit 4A and the second lamp unit 4B are gripped and are pulled to the side in the direction opposite to the Z direction, thereby removing the first lamp unit 4A and the second lamp unit 4B from the projector 1. Then, the grip section 531 of the optical path changing device 5 is pulled to the side in the direction opposite to the Z direction, thereby making it possible to remove the optical path changing device 5 from the projector 1. Further, movement of the optical path changing device 5 is regulated by the extending sections 421A and 421B in the direction parallel to the Z direction. Therefore, when the optical path changing device 5 is removed from the projector 1, first, the first lamp unit 4A and the second lamp unit 4B need to be removed.

### Optical Path Change by Optical Path Changing Device

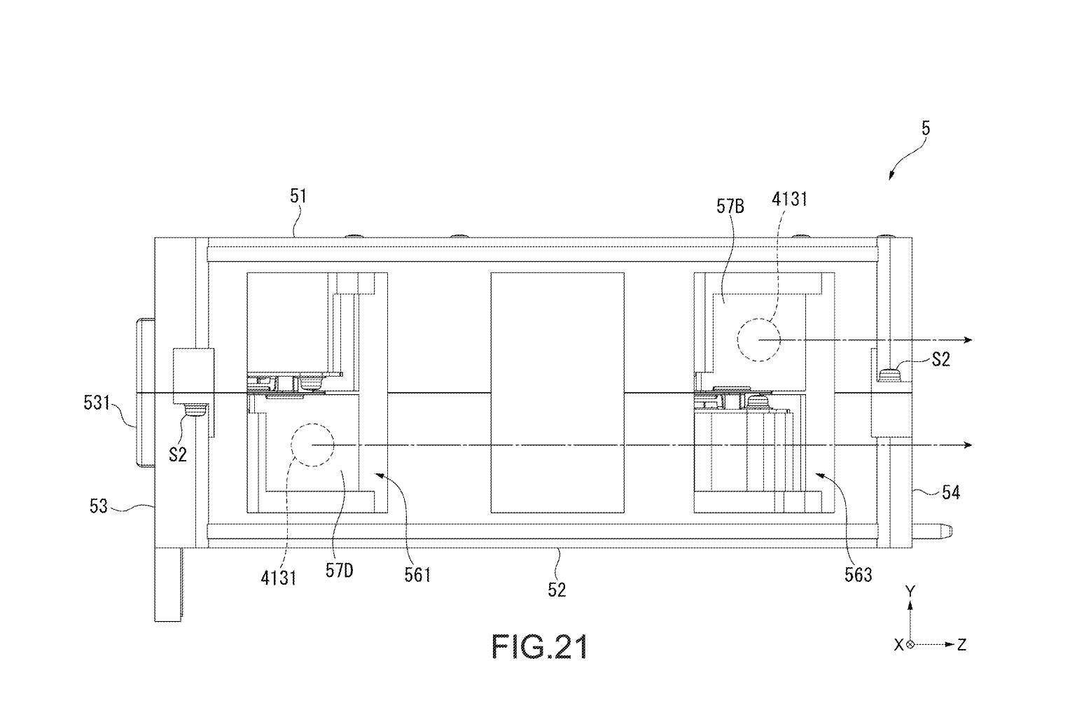

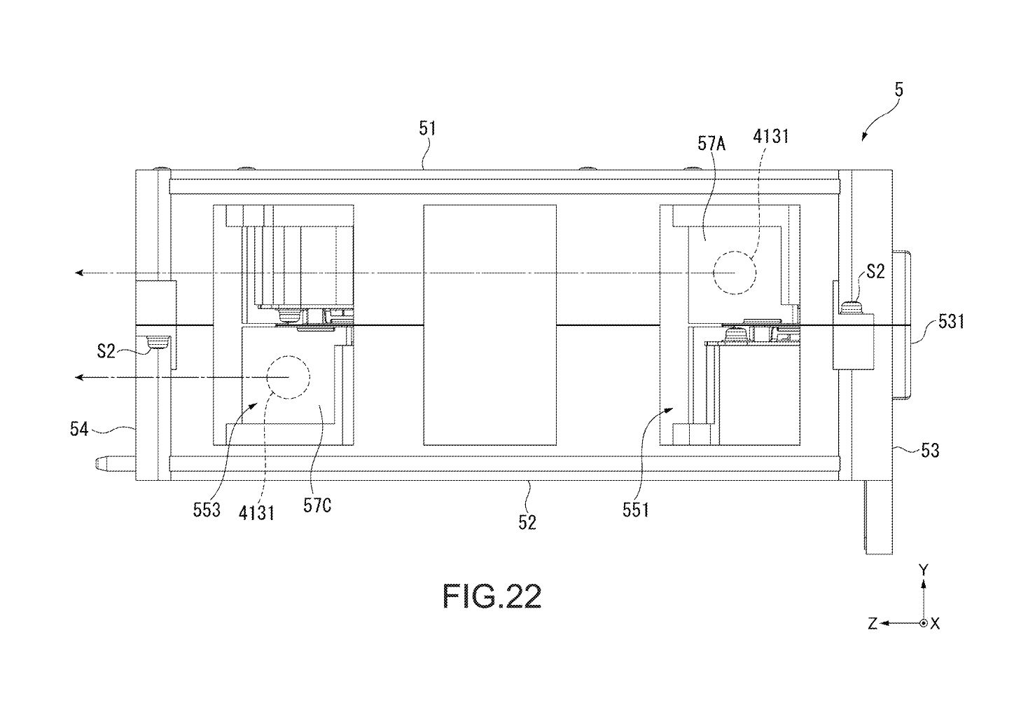

FIG. 21 is a side view illustrating the optical path changing device 5 when viewed from the side in the direction opposite to the X direction. FIG. 22 is a side view illustrating the optical path changing device 5 when viewed from the X direction side. Further, in FIGS. 21 and 22, the openings 4131 of the light source devices 41A to 41D corresponding to the reflective mirrors 57A to 57D, respectively, are depicted in a dash line.

According to the configuration described above, the optical path changing device 5 aligns and emits the light beams emitted from the light source devices 41 (41A to 41D) in the Z direction and causes the light beams to be incident to the equalizing device 32. Specifically, as illustrated in FIGS. 3 and 21, the emitted light beam L41 emitted from the opening 4131 of the light source device 41D is incident to the reflective mirror 57D through the opening 561 of the optical path changing device 5 and is reflected from the reflective mirror 57D toward the Z direction. In addition, as illustrated in FIGS. 3 and 21, the emitted light beam. L21 emitted from the opening 4131 of the light source device 41B is incident to the reflective mirror 57B through the opening 563 of the optical path changing device 5 and is reflected from the reflective mirror 57B toward the Z direction.

In addition, as illustrated in FIGS. 3 and 22, the emitted light beam L11 emitted from the opening 4131 of the light source device 41A is incident to the reflective mirror 57A through the opening 551 of the optical path changing device 5 and is reflected from the reflective mirror 57A toward the Z direction. In addition, as illustrated in FIGS. 3 and 22, the emitted light beam L31 emitted from the opening 4131 of the light source device 41C is incident to the reflective mirror 57C through the opening 553 of the optical path changing device 5 and is reflected from the reflective mirror 57C toward the Z direction.

### Cooling Path of Optical Path Changing Device

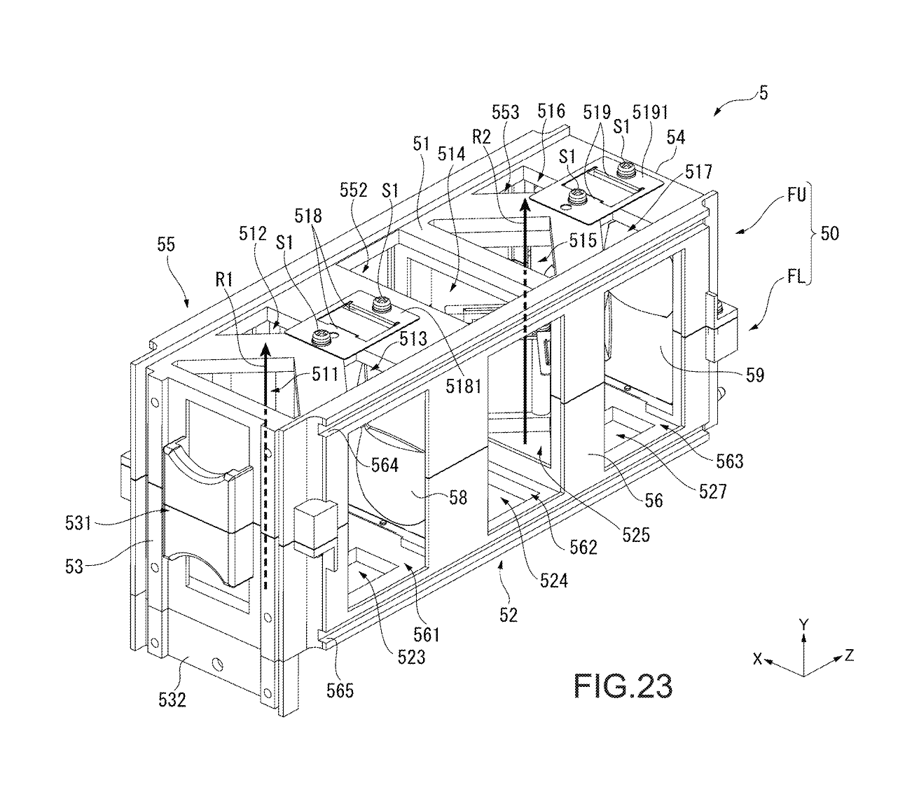

FIG. 23 is a view illustrating flow paths of cooling gases R1 and R2 that cool the optical path changing device 5.

The optical path changing device 5 is cooled by the cooling device 9 disposed in the projector 1. Specifically, a duct of the cooling device 9 is disposed on the side in the direction opposite to the Y direction from the optical path changing device 5 (lower surface 52 side) and a projection opening of the duct is disposed at a position facing the openings 521 and 525 of the optical path changing device 5 (not illustrated). In this manner, the cooling gas R1 supplied from the cooling device 9 is circulated from the opening 521 toward the opening 511. In addition, the cooling gas R2 is circulated from the opening 525 toward the opening 515. In this manner, the surface of the holding sections 571A and 571D that hold the reflective mirrors 57A and 57D on the side in the direction opposite to the Z direction is cooled by the cooling gas R1, and the surface of the holding sections 571B and 571C that hold the reflective mirrors 57B and 57C on the side in the direction opposite to the Z direction is cooled by the cooling gas R2. In other words, the cooling gases R1 and R2 cool the holding sections 571A to 571D, thereby, making it possible to cool the reflective mirrors 57A to 57D which are held in the holding sections 571A to 571D. In other words, it is possible to cool the reflective mirrors 57A to 57D without circulating the cooling gases R1 and R2 directly to the reflective mirrors 57A to 57D (reflective surfaces of the reflective mirrors 57A to 57D).

In the projector 1 according to the present embodiment, it is possible to achieve the following effects.

It is possible to configure the optical path changing device 5 that is attachable to and detachable from the base member 36 of the projector 1 and that includes the housing 50 in which the plurality of reflective mirrors 57A to 57D are provided. In this manner, since the optical path changing device 5 can be removed from the inside of the projector 1, it is possible to easily perform cleaning of dust attached to the reflective mirrors 57A to 57D, compared to a case where the reflective mirrors 57A to 57D are directly fixed to the projector 1.

The grip section 531 is provided on the side opposite to the accommodating direction of the optical path changing device 5 to the base member 36. In this manner, since an operator can move the optical path changing device 5 by gripping the grip section 531, it is possible to easily attach and detach the optical path changing device 5 to and from the projector 1.

In addition, when the optical path changing device 5 is accommodated in the projector 1, it is possible to easily move the optical path changing device 5 along the guide rails 554, 555, 564, and 565. In this manner, it is possible to easily mount the optical path changing device 5 on the base member 36 of the projector 1 and it is possible to easily remove the optical path changing device.

Since it is possible to collimate the light beam reflected from the reflective mirrors 57A to 57D by the first lens 58 and the second lens 59 as the optical conversion components, it is possible to emit the collimated light beam from the optical path changing device 5. In addition, since the optical path changing device 5 can be attached to and detached from the base member of the projector 1 despite the first lens 58 and the second lens 59 being provided, the housing (optical path changing device 5) is removed from the projector 1 and it is possible to easily perform cleaning of the dust attached to the reflective mirrors 57A to 57D and the first lens 58 and the second lens 59.

After the optical path changing device 5 is removed from the projector 1, one of the first frame member FU or the second frame member FL is removed, and then the reflective mirrors 57A to 57D, the first lens 58, and the second lens 59 are in a state of being exposed to the outside of the housing 50. In this manner, it is possible to easily perform cleaning of the dust attached to the reflective mirrors 57A to 57D, the first lens 58, and the second lens 59.

The extending sections 421A and 421B of the first lamp unit 4A and the second lamp unit 4B can suppress detachment of the optical path changing device 5 from the projector 1. In this manner, since the optical path changing device 5 is reliably fixed to the projector 1, the optical path changing device 5 can reliably reflect the light beam emitted from the first lamp unit 4A and the second lamp unit 4B in the predetermined reflection direction (Z direction).

### Modification of Embodiment

The invention is not limited to the embodiment described above, but includes alteration, modification, or the like, of the invention within a range in which the objects of the invention are achieved.

In the embodiment, the grip section 531 is provided on the light shielding surface 53 of the optical path changing device 5. However, the invention is not limited thereto. For example, the grip section 531 may be provided at a position other than the light shielding surface 53 or may not be provided at any position. In addition, the first and second lamp units 4A and 4B include the grip sections 422A and 422B. However, the invention is not limited thereto. For example, the grip sections 422A and 422B may not be provided. In other words, as long as it is possible to remove the first lamp unit 4A, the second lamp unit 4B, and the optical path changing device 5 from the projector 1, the grip section may not be provided.

In the embodiment, the guide rails 554, 555, 564, and 565 are provided on the outer surface of the housing 50 constituting the optical path changing device 5. However, the invention is not limited thereto. For example, the housing 50 may not include the guide rails 554, 555, 564, and 565.

In the embodiment, the housing 50 includes the first frame member FU and the second frame member FL. However, the invention is not limited thereto. For example, the first frame member FU may not be integral with the second frame member FL. In this case, since the optical path changing device 5 is removed to the outside of the projector 1, it is also possible to easily perform cleaning, compared to a case where the reflective mirrors 57A to 57D, the first lens 58, and the second lens 59 are mounted in the exterior housing 2 of the projector 1.

In the embodiment, the direction in which the first frame member FU and the second frame member FL constituting the housing 50 face each other is the Y direction. However, the invention is not limited thereto. For example, the facing direction may be the X direction or may be the Z direction.

In the embodiment, the first lens 58 or the first and second lenses 58 and 59 that collimate the incident light beam are provided. However, the invention is not limited thereto. For example, the optical path changing device 5 may not include the first and second lenses 58 and 59. In this case, the emitted light beams L12 to L42 reflected from the reflective mirrors 57A to 57D may be supplied to the equalizing device 32.

In addition, without the first lens 58, the small lenses 582A and 582D of the first lens 58 may be provided to the second lens 59. Further, instead of the first lens 58, four collimating lenses may be provided for the light source devices 41A to 41D, respectively.

In the embodiment, the reflective mirrors 57A to 57D are provided to correspond to the light source devices 41A to 41D, respectively. However, the invention is not limited thereto. For example, there may be provided a reflective mirror in which the reflective mirrors 57A and 57D and the reflective mirrors 57B and 57C are integrated.

In the embodiment, the height position of the light source device 41A and the light source device 41B in the Y direction is configured to be higher than the height position of the light source device 41C and the light source device 41D. However, the invention is not limited thereto. For example, the height position of the light source device 41A and the light source device 41B may be lower than the height position of the light source device 41C and the light source device 41D.

In the embodiment, the height position of the light source device 41A is substantially the same as the height position of the light source device 41B, and the height position of the light source device 41C is substantially the same as the height position of the light source device 41D. However, the invention is not limited thereto. For example, the height position of the light source device 41A may be different from the height position of the light source device 41B, and the height position of the light source device 41C may be different from the height position of the light source device 41D.

In the embodiment, the first lamp unit 4A and the second lamp unit 4B are disposed to interpose the optical path changing device 5 therebetween. However, the invention is not limited thereto. For example, the first and second lamp units 4A and 4B may be disposed to be parallel in the Z direction on one side of the optical path changing device 5 or may be disposed to be overlapped in the Y direction. In this case, the reflective mirrors 57A to 57D of the optical path changing device 5 may be disposed at positions corresponding to the light source devices 41A to 41D of the first and second lamp units 4A and 4B.

In the embodiment, the first frame member FU and the second frame member FL are molded by the aluminum die casting. However, the invention is not limited thereto. For example, the frame members may be molded by magnesium die casting. Further, the frame members F may be molded by die casting.

In the embodiment, the first frame member FU and the second frame member FL constituting the housing 50 have substantially the same shape. However, the invention is not limited thereto. For example, the first frame member FU and the second frame member FL may have different shapes. In other words, as long as the first frame member FU and the second frame member FL constituting the housing 50 have substantially the same dimension in the direction (direction parallel to the Y direction) in which the members are assembled, the shapes may be different.

In the embodiment, as the light modulating device, transmission liquid crystal panels 341 (341R, 341G, and 341B) are used. However, the invention is not limited thereto. For example, instead of the transmission liquid crystal panels 341 (341R, 341G, and 341B), reflective liquid crystal panels may be used. In this case, the color separator 33 may not be provided, and the color synthesis device 344 may perform the color separation and the color synthesis.

In the embodiment, the projector 1 includes the three transmission liquid crystal panels 341 (341R, 341G, and 341B); however, the invention is not limited thereto. In other words, the invention is applicable to a projector using two or less or four or more liquid crystal panels.

In addition, instead of the liquid crystal panel, a digital micromirror device or the like may be used.

In the embodiment, the light source devices 41A to 41D include the luminous tube 411, the reflector 412, and the accommodation body 413. However, the invention is not limited thereto. For example, a light emitting diode (LED), a laser diode (LD), or the like, may be provided.

In the embodiment, the projector 1 includes the light source devices 41A to 41D. However, the invention is not limited thereto. For example, six or eight light source devices may be provided.

In the embodiment, the image forming device 3 is configured to have a substantial U shape; however, the invention is not limited thereto. For example, an image forming device configured to have a substantial L shape may be employed.

### CROSS REFERENCE TO RELATED APPLICATIONS

This application claims priority to Japanese Patent Application No. 2015-118091 filed on Jun. 11, 2015, the entire contents of which are incorporated by reference herein.

What is claimed is:

1. An optical path changing device that is accommodated in an accommodation section of a projector having a plurality of light sources and that aligns a traveling direction of an incident light beam and emits the light beam, the optical path changing device comprising:
a reflective member that aligns and reflects alight beam incident from each of the plurality of light sources in a predetermined reflection direction;
a housing holding the reflective member; and
a mounting section which is detachably mounted in the accommodation section.

2. The optical path changing device according to claim 1,
wherein at an end portion of the housing, there is provided a grip section that is gripped when the optical path changing device is attached and detached, and
wherein the mounting section is provided on an exterior surface of the housing and is formed in a direction in which the optical path changing device is attached to and detached from the accommodation section.

3. The optical path changing device according to claim 1, further comprising:
a plurality of the reflective members corresponding to the plurality of light sources; and
an optical conversion component that changes optical properties of a light beam reflected from the plurality of reflective members,
wherein the housing includes
a reflective member holding section that holds the plurality of reflective members, and
an optical conversion component holding section that holds the optical conversion component.

4. The optical path changing device according to claim 3,
wherein the housing is configured to include a first member and a second member which are assembled to each other, and
wherein a direction, in which the first member and the second member face each other, is a direction substantially orthogonal to the reflection direction.

5. A projector comprising:
an illuminating device that emits a light beam; and
an exterior housing having an accommodation section that accommodates the illuminating device inside,
wherein the illuminating device includes
the optical path changing device according to claim 1, and
a light source unit having a plurality of light sources that emit a light beam toward the optical path changing device, and
wherein the light source unit has a regulation section that regulates detachment of the optical path changing device accommodated in the accommodation section.

6. A projector comprising:
an illuminating device that emits a light beam; and
an exterior housing having an accommodation section that accommodates the illuminating device inside,
wherein the illuminating device includes
the optical path changing device according to claim 2, and
a light source unit having a plurality of light sources that emit a light beam toward the optical path changing device, and
wherein the light source unit has a regulation section that regulates detachment of the optical path changing device accommodated in the accommodation section.

7. A projector comprising:
an illuminating device that emits a light beam; and
an exterior housing having an accommodation section that accommodates the illuminating device inside,
wherein the illuminating device includes
the optical path changing device according to claim 3, and
a light source unit having a plurality of light sources that emit a light beam toward the optical path changing device, and
wherein the light source unit has a regulation section that regulates detachment of the optical path changing device accommodated in the accommodation section.

8. A projector comprising:
an illuminating device that emits a light beam; and
an exterior housing having an accommodation section that accommodates the illuminating device inside,
wherein the illuminating device includes
the optical path changing device according to claim 4, and
a light source unit having a plurality of light sources that emit a light beam toward the optical path changing device, and
wherein the light source unit has a regulation section that regulates detachment of the optical path changing device accommodated in the accommodation section.
